(19) United States
(12) Patent Application Publication
(10) Pub. No.: US 2017/0249144 A1
(43) Pub. Date: Aug. 31, 2017

(54) COMBINING LOADS OR STORES IN COMPUTER PROCESSING

(71) Applicant: QUALCOMM Incorporated, San Diego, CA (US)

(72) Inventors: Kevin JAGET, Cary, NC (US); Michael William MORROW, Wilkes-Barre, PA (US); James Norris DIEFFENDERFER, Apex, NC (US)

(21) Appl. No.: 15/055,160

(22) Filed: Feb. 26, 2016

(51) Int. Cl. G06F 9/30

(52) U.S. Cl. CPC G06F 9/3017; G06F 9/30145; G06F 9/3004; G06F 9/30021

(57) ABSTRACT

Aspects disclosed herein relate to combining instructions to load data from or store data in memory while processing instructions in processors. An exemplary method includes detecting a pattern of pipelined instructions to access memory using a first portion of available bus width and, in response to detecting the pattern, combining the pipelined instructions into a single instruction to access the memory using a second portion of the available bus width that is wider than the first portion. Devices including processors using disclosed aspects may execute currently available software in a more efficient manner without the software being modified.

### BACKGROUND

Aspects disclosed herein relate to the field of computer processors. More specifically, aspects disclosed herein relate to combining instructions to load data from or store data in memory while processing instructions in processors.

In processing, a pipeline is a set of data processing elements connected in series, where the output of one element is the input of the next one. Instructions are fetched and placed into the pipeline sequentially. In this way multiple instructions can be present in the pipeline as an instruction stream and can be all processed simultaneously, although each instruction will be in a different stage of processing in the stages of the pipeline.

A processor may support a variety of load and store instruction types. Not all of these instructions may take full advantage of a bandwidth of an interface between the processor and an associated cache or memory. For example, a particular processor architecture may have load (e.g., fetch) instructions and store instructions that target a single 32-bit word, while recent processors may supply a data-path to the cache of 64 or 128 bits. That is, compiled machine code of a program may include instructions that load a single 32-bit word of data from a cache or other memory, while an interface (e.g., a bus) between the processor and the cache may be 128 bits wide, and thus 96 bits of the width are unused during the execution of each of those load instructions. Similarly, the compiled machine code may include instructions that store a single 32-bit word of data in a cache or other memory, and thus 96 bits of the width are unused during the execution of each of those store instructions.

### SUMMARY

Aspects disclosed herein relate to combining instructions to load data from or store data in memory while processing instructions in processors.

In one aspect, a method is provided. The method generally includes detecting a pattern of pipelined instructions to access memory using a first portion of available bus width and, in response to detecting the pattern, combining the instructions into a single instruction to access the memory using a second portion of the available bus width that is wider than the first portion.

In another aspect, a processor is provided. The processor generally includes a pattern detection circuit configured to detect a pattern of pipelined instructions to access memory using a first portion of available bus width and, in response to detecting the pattern, combine the instructions into a single instruction to access the memory using a second portion of the available bus width that is wider than the first portion.

In still another aspect, an apparatus is provided. The apparatus generally includes means for detecting a pattern of pipelined instructions to access memory using a first portion of available bus width and means for combining, in response to detecting the pattern, the instructions into a single instruction to access the memory using a second portion of the available bus width that is wider than the first portion.

The claimed aspects may provide one or more advantages over previously known solutions. According to some aspects, load and store operations may be performed in a manner that uses available memory bandwidth more efficiently, which may improve performance and reduce power consumption.

### BRIEF DESCRIPTION OF THE SEVERAL VIEWS OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIG. 1 is a functional block diagram of an exemplary processor configured to recognize sequences of instructions that may be replaced by a more bandwidth-efficient instruction, according to aspects of the present disclosure.

FIG. 2 is a flow chart illustrating a method for computing, according to aspects of the present disclosure.

FIG. 3 illustrates an exemplary processor pipeline, according to aspects of the present disclosure.

FIG. 4 illustrates an exemplary storage instruction table (SIT), according to aspects of the present disclosure.

FIG. 5 is a block diagram illustrating a computing device, according to aspects of the present disclosure.

### DETAILED DESCRIPTION

Aspects disclosed herein provide a method for recognizing sequences (e.g., patterns or idioms) of smaller load instructions (loads) or store instructions (stores) targeting adjacent memory in a program (e.g., using less than the full bandwidth of a data-path) and combining these smaller loads or stores into a larger (e.g., using more of the bandwidth of the data-path) load or store. The data-path may comprise a bus, and the bandwidth of the data-path may be the number of bits that the bus may convey in a single operation. For example (illustrated with assembly code), the sequence of loads:

LDR R0, [SP, #8]; load R0 from memory at SP+8

LDR R1, [SP, #12]; load R1 from memory at SP+12

may be recognized as a pattern that could be replaced with a more bandwidth-efficient command or sequence of commands, because each of the loads uses only 32 bits of bandwidth (e.g., a bit-width of 32 bits) while accessing memory twice. In the example, the sequence may be replaced with the equivalent (but more bandwidth-efficient) command:

LDRD R0, R1, [SP, #8]; load R0 and R1 from memory at SP+8

that uses 64 bits of bandwidth (e.g., a bit-width of 64 bits) while accessing memory once. Replacing multiple “narrow” instructions with a “wide” instruction may allow higher throughput to caches or memory and reduce the overall instruction count executed by the processor.

According to aspects of the present disclosure, the recognition of sequences as replaceable and the replacement of the sequences may be performed in a processing system including at least one processor, such that each software sequence is transformed on the fly in the processing system each time the software sequence is encountered. Thus, implementing the provided methods does not involve any change to existing software. That is, software that can run on a device not including a processing system operating according to aspects of the present disclosure may be run on a device including such a processing system with no changes to the software. The device including the processing system operating according to aspects of the present disclosure may perform load and store operations in a more bandwidth-efficient manner (than a device not operating according to aspects of the present disclosure) by replacing some load and store commands while executing the software, as described above and in more detail below.

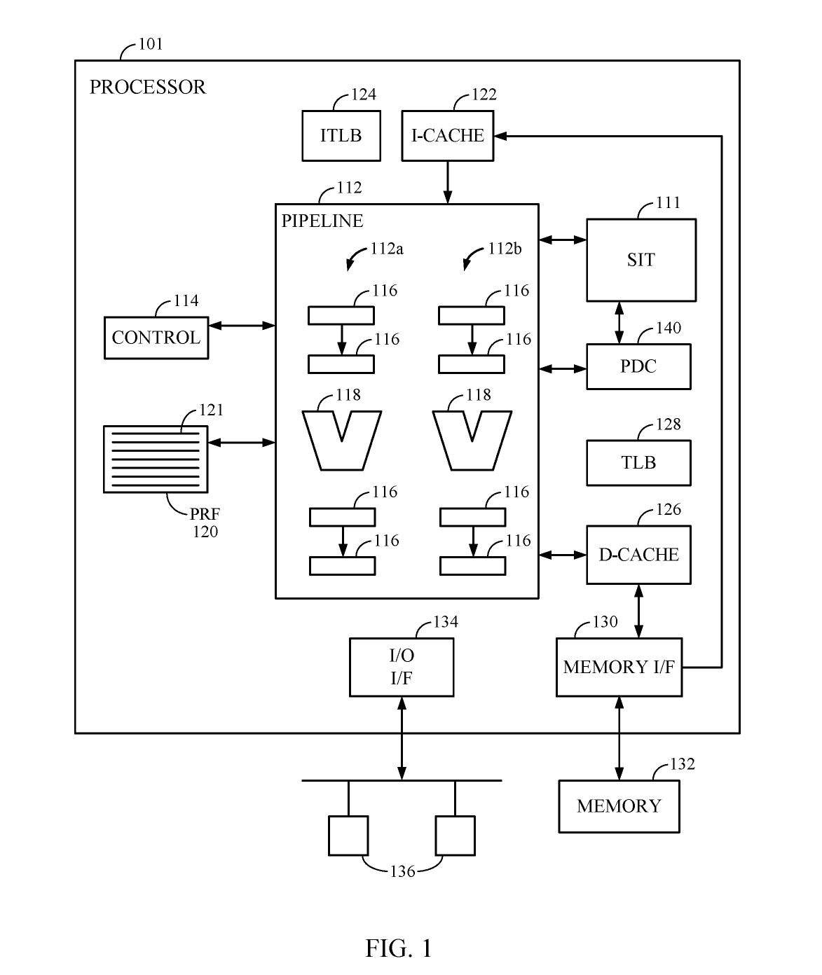

FIG. 1 is a functional block diagram of an example processor (e.g., a CPU) 101 configured to recognize sequences of instructions that may be replaced by a more bandwidth-efficient instruction, according to aspects of the present disclosure described in more detail below. Generally, the processor 101 may be used in any type of computing device including, without limitation, a desktop computer, a laptop computer, a tablet computer, and a smart phone. Generally, the processor 101 may include numerous variations, and the processor 101 shown in FIG. 1 is for illustrative purposes and should not be considered limiting of the disclosure. For example, the processor 101 may be a central processing unit (CPU), a graphics processing unit (GPU), a digital signal processor (DSP), or another type of processor. In one aspect, the processor 101 is disposed on an integrated circuit including an instruction execution pipeline 112 and a storage instruction table (SIT) 111.

Generally, the processor 101 executes instructions in an instruction execution pipeline 112 according to control logic 114. The pipeline 112 may be a superscalar design, with multiple parallel pipelines, including, without limitation, parallel pipelines 112a and 112b. The pipelines 112a, 112b include various non-architected registers (or latches) 116, organized in pipe stages, and one or more arithmetic logic units (ALU) 118. A physical register file 120 includes a plurality of architected registers 121.

The pipelines 112a, 112b may fetch instructions from an instruction cache (I-Cache) 122, while an instruction-side translation lookaside buffer (ITLB) 124 may manage memory addressing and permissions. Data may be accessed from a data cache (D-cache) 126, while a main translation lookaside buffer (TLB) 128 may manage memory addressing and permissions. In some aspects, the ITLB 124 may be a copy of a part of the TLB 128. In other aspects, the ITLB 124 and the TLB 128 may be integrated. Similarly, in some aspects, the I-cache 122 and D-cache 126 may be integrated, or unified. Misses in the I-cache 122 and/or the D-cache 126 may cause an access to higher level caches (such as L2 or L3 cache) or main (off-chip) memory 132, which is under the control of a memory interface 130. The processor 101 may include an input/output interface (I/O IF) 134 that may control access to various peripheral devices 136.

The processor 101 also includes a pattern detection circuit (PDC) 140. As used herein, a pattern detection circuit comprises any type of circuitry (e.g., logic gates) configured to recognize sequences of reads from or stores to caches and memory and replace recognized sequences with commands that are more bandwidth-efficient, as described in more detail herein. Associated with the pipeline or pipelines 112 is a storage instruction table (STI) 111 that may be used to maintain attributes of read commands and write commands that pass through the pipelines 112, as will be described in more detail below.

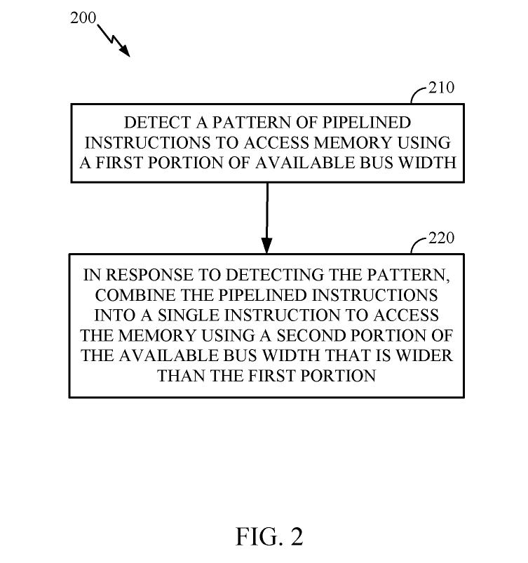

FIG. 2 is a flow chart illustrating a method 200 for computing that may be performed by a processor, according to aspects of the present disclosure. In at least one aspect, the PDC is used in performing the steps of the method 200. The method 200 depicts an aspect where the processor detects instructions that access adjacent memory and replaces the instructions with a more bandwidth-efficient instruction, as mentioned above and described in more detail below.

At block 210, the method begins by the processor (e.g., the PDC) detecting a pattern of pipelined instructions (e.g., commands) to access memory using a first portion of available bus width. As described in more detail below, the processor may detect patterns wherein the instructions are consecutive, non-consecutive, or interleaved with other detected patterns. Also as described in more detail below, the processor may detect a pattern wherein instructions use a same base register with differing offsets, instructions use addresses relative to a program counter that is increased as instructions execute, or instructions use addresses relative to a stack pointer.

At block 220, the method continues by the processor, in response to detecting the pattern, combining the pipelined instructions into a single instruction to access the memory using a second portion of the available bus width that is wider than the first portion. The processor 101 may replace the pattern of instructions with the single instruction before passing the single instruction and possibly other (e.g., unchanged) instructions from Decode stage to an Execute stage in a pipeline.

The various operations described above may be performed by any suitable means capable of performing the corresponding functions. The means may include circuitry and/or module(s) of a processor or processing system. For example, means for detecting (a pattern of pipelined instructions to access memory using a first portion of available bus width) may be implemented in the pattern detection circuit 140 of the processor 101 shown in FIG. 1. Means for combining the pipelined instructions (in response to detecting the pattern, into a single instruction to access the memory using a second portion of the available bus width that is wider than the first portion) may be implemented in any suitable circuit of the processor 101 shown in FIG. 1, including the pattern detection circuit 140, circuits within the pipeline(s) 112, and/or the control logic 114.

According to aspects of the present disclosure, a processor (e.g., processor 101 in FIG. 1) may recognize consecutive (e.g., back-to-back) loads (e.g., instructions that load data from a location) or stores (e.g., instructions that store data to a location) as a sequence of loads or stores targeting memory at contiguous offsets. Examples of these are provided below:

STR R4, [R0]; 32b R4 to memory at R0+0

STR R5, [R0, #4]; 32b R5 to memory at R0+4

STRB R1, [SP, #−5]; 8b R1 to memory at SP-5

STRB R2, [SP, #−4]; 8b R2 to memory at SP-4

VLDR D2, [R8, #8]; 64b D2 from memory at R8+8

VLDR D7, [R8, #16]; 64b D7 from memory at R8+16

In the first pair of commands, a 32-bit value from register R4 is written to a memory location located at a value stored in the R0 register, and then a 32-bit value from register R5 is written to a memory location four addresses (32 bits) higher than the value stored in the R0 register. In the second pair of commands, an eight-bit value from register R1 is written to a memory location located five addresses lower than a value stored in the stack pointer (SP), and then an eight-bit value from register R2 is written to a memory location located four addresses lower than the value stored in the SP, i.e., one address or eight bits higher than the location to which R1 was written. In the third pair of commands, a 64-bit value is read from a memory location located eight addresses higher than a value stored in register R8, and then a 64-bit value is read from a memory location located sixteen addresses higher than the value stored in register R8, i.e. eight addresses or 64 bits higher than the location read from in the first command. A processor operating according to aspects of the present disclosure may recognize consecutive commands accessing memory at contiguous offsets, such as those above, as a pattern that may be replaced by a command that is more bandwidth-efficient. The processor may then replace the consecutive commands with the more bandwidth-efficient command as described above with reference to FIG. 2.

According to aspects of the present disclosure, a processor may recognize consecutive (e.g., back-to-back) loads or stores with base-updates as a pattern of commands that access contiguous memory that may be replaced by a command that is more bandwidth-efficient. As used herein, the term base-update generally refers to an instruction that alters the value of an address-containing register used in a sequence (e.g., a pattern) of commands. A processor may recognize that a sequence of commands targets adjacent memory when base-updates in the commands are considered. For example, in the below pair of instructions, data is read from adjacent memory locations due to the base-update in the first command:

LDR R7, [R0], #4; 32b from memory at R0; R0=R0+4

LDR R3, [R0]; 32b from memory at R0

A processor operating according to aspects of the present disclosure may recognize consecutive commands with base-updates, such as those above, as a pattern that may be replaced by a command that is more bandwidth-efficient, and then replace the commands as described above with reference to FIG. 2.

According to aspects of the present disclosure, a processor may recognize consecutive (e.g., back-to-back) program-counter-relative (PC-relative) loads or stores as a pattern which may be replaced by a command that is more bandwidth efficient. A processor may recognize that a sequence of commands targets adjacent memory when changes to the program counter (PC) are considered. For example, in the below pair of instructions, data is read from adjacent memory locations due to the PC changing after the first command is executed.

LDR R1, [PC, #20]; PC=X, load from memory at X+20+8

LDR R2, [PC, #20]; load from memory at X+4+20+8

In the above pair of instructions, a 32-bit value is read from a memory location located 28 locations (224 bits) higher than a first value (X) of the PC, the PC is advanced four locations, and then another 32-bit value is read from the memory location located 32 locations (256 bits) higher than the first value (X) of the PC. Thus, the above pair of commands may be replaced as shown below:

$$\{ \begin{matrix}LDR & R 1 , [ PC , \#20 ] & PC = X , \\ & & load from memory at X + 20 + 8 \\ LDR & R 2 , [ PC , \#20 ] & load from memory at X + 4 + 20 + 8\end{matrix} \} \text{=} \text{>}$$

$$\begin{matrix}LDRD & R 1 , R 2 , [ PC , \#20 ]\end{matrix}$$

According to aspects of the present disclosure, a processor may recognize a non-consecutive (e.g., non-back-to-back) sequence of loads or stores as a sequence of loads or stores targeting memory at adjacent locations. If there are no intervening instructions that will alter addresses referred to by loads or stores in a program, then it may be possible to pair those loads or stores and replace the paired loads or stores with a more bandwidth-efficient command. For example, in the below set of instructions, data is read from adjacent memory locations in non-consecutive LDR (load) commands, and the memory locations being read are not altered by any of the intervening commands.

LDR R1, [R0]; 32b from memory at R0

MOV R2, #42; doesn't alter address register (R0)

ADD R3, R2; doesn't alter address register (R0)

LDR R4, [R0, #4]; 32b from memory at R0+4

In the above set of instructions, the first and fourth instructions may be replaced with a single read command targeting the eight adjacent memory locations starting at the location specified by the value in the R0 register because the second and third instructions do not alter any of those eight adjacent memory locations as shown below:

{LDR R1, [R0]; 32b from memory at R0}=>

MOV R2, #42; doesn't alter address register (R0)

ADD R3, R2; doesn't alter address register (R0)

{LDR R4, [R0, #4]; 32b from memory at R0+4}=>

LDRD R1, R4, [R0]

While the replacement instruction (for the original first and fourth instructions) is shown below the intervening instructions in the list above, this order is for convenience and is not intended to be limiting of the order of the commands as they are passed to an Execute stage of a pipeline. In particular, the replacement instruction may be passed to an Execute stage of a pipeline before, between, or after the intervening instructions.

The patterns described above may occur in non-consecutive (e.g., non-back-to-back) variations. Thus, a processor operating according to the present disclosure may recognize any of the previously described patterns with intervening instructions that do not alter any of the targeted adjacent memory locations and replace the recognized patterns with equivalent commands that are more bandwidth-efficient.

For example, in each of the below sets of instructions, data is read from or stored in adjacent memory locations in non-consecutive commands, and the memory locations being accessed are not altered by any of the intervening commands.

LDR R0, [SP, #8]; load R0 from memory at SP+8

MOV R3, #60; doesn't alter memory at SP+8 or SP+12

LDR R1, [SP, #12]; load R1 from memory at SP+12

STR R4, [R0]; 32b R4 to memory at R0+0

MOV R2, #21; doesn't alter memory at R0 or R0+4

STR R5, [R0, #4]; 32b R5 to memory at R0+4

STRB R1, [SP, #−5]; 8b R1 to memory at SP−5

MOV R2, #42; doesn't alter memory at SP−5 or SP−4

STRB R2, [SP, #−4]; 8b R2 to memory at SP−4

VLDR D2, [R8, #8]; 64b D2 from memory at R8+8

ADD R1, R2; doesn't alter memory at R8+8 or R8+16

VLDR D7, [R8, #16]; 64b D2 from memory at R8+16

In each of the above sets of instructions, memory at adjacent locations is targeted by commands performing similar operations with intervening commands that do not alter the memory locations. A processor operating according to aspects of the present disclosure may recognize non-consecutive commands, such as those above, as a pattern that may be replaced by a command that is more bandwidth-efficient, and then replace the commands as described above with reference to FIG. 2 while leaving the intervening commands unchanged.

According to aspects of the present disclosure, a processor may recognize non-consecutive (e.g., non-back-to-back) loads or stores with base-updates as a pattern which may be replaced by a command that is more bandwidth-efficient. For example, in the below set of instructions, data is read from adjacent memory locations due to the base-update in the first command:

LDR R7, [R0], #4; 32b from memory at R0; R0=R0+4

ADD R1, R2; doesn't alter memory at R0 or R0+4

LDR R3, [R0]; 32b from memory at R0

Thus, the first and third commands may be replaced by a single load command, as shown below:

{LDR R7, [R0], #4; 32b from memory at R0; R0=R0+4}=>

ADD R1, R2; doesn't alter memory at R0 or R0+4

{LDR R3, [R0]; 32b from memory at R0}=>

LDRD R7, R3, [R0], #4

A processor operating according to aspects of the present disclosure may recognize non-consecutive commands with base-updates as a pattern that may be replaced by a more bandwidth-efficient command, and then replace the non-consecutive commands with the more bandwidth-efficient command as described above with reference to FIG. 2.

According to aspects of the present disclosure, a processor may recognize non-consecutive (e.g., non-back-to-back) PC-relative loads or stores as a pattern which may be replaced by a command that is more bandwidth-efficient. A processor may recognize that a sequence of commands targets adjacent memory when changes to the program counter (PC) are considered and intervening commands do not alter the targeted memory. For example, in the below set of instructions, data is read from adjacent memory locations due to the PC changing after the first command is executed.

LDR R1, [PC, #20]; PC=X, load from memory at X+20+8

MOV R2, #42; doesn't alter memory at X+28 or X+32

LDR R3, [PC, #16]; load from memory at X+8+16+8

Thus, the first and third commands may be replaced by a single load command, as shown below:

{LDR R1, [PC, #20]; PC=X, load from memory at X+20+8}=>

MOV R2, #42; doesn't alter memory at X+28 or X+32

{LDR R3, [PC, #16]; load from memory at X+8+16+8}=>

LDRD R1, R3, [PC, #20]

A processor operating according to aspects of the present disclosure may recognize non-consecutive PC-relative commands as a pattern that may be replaced by a more bandwidth-efficient command, and then replace the non-consecutive commands with the more bandwidth-efficient command as described above with reference to FIG. 2.

According to aspects of the present disclosure, a processor operating according to the present disclosure may recognize any of the previously described patterns (e.g., sequences) interleaved with another of the previously described patterns and replace the recognized patterns with equivalent commands that are more bandwidth-efficient. That is, in a group of commands, two or more pairs of loads or stores may be eligible to be replaced by the processor with more bandwidth-efficient commands. For example, in the below set of instructions, data is read from adjacent memory locations by a first pair of instructions and from a different set of adjacent memory locations by a second pair of instructions.

LDR R1, [R0], #4; 32b from memory at R0; R0=R0+4

LDR R7, [SP]; 32b from memory at SP

LDR R4, [R0]; 32b from memory at R0 (pair with 1^{st} LDR)

LDR R5, [SP, #4]; 32b from memory at SP+4 (pair with 2^{nd} LDR)

A processor operating according to aspects of the present disclosure may recognize interleaved patterns of commands that may be replaced with more bandwidth-efficient commands. Thus, a processor operating according to aspects of the present disclosure that encounters the above exemplary pattern may replace the first and third instructions with an instruction that is more bandwidth-efficient and replace the second and fourth instructions with an instruction that is more bandwidth-efficient.

According to aspects of the present disclosure, any of the previously described patterns may be detected by a processor examining a set of instructions in an instruction set window of a given width of instructions. That is, a processor operating according to aspects of the present disclosure may examine a number of instructions in an instruction set window to detect patterns of instructions that access adjacent memory locations and may be replaced with instructions that are more bandwidth-efficient.

According to aspects of the present disclosure, any of the previously described patterns of instructions may be detected by a processor and replaced with more bandwidth-efficient (e.g., “wider”) instructions during program execution. In some cases, the pattern recognition and command (e.g., instruction) replacement may be performed in a pipeline of a processor, such as pipelines 112 shown in FIG. 1.

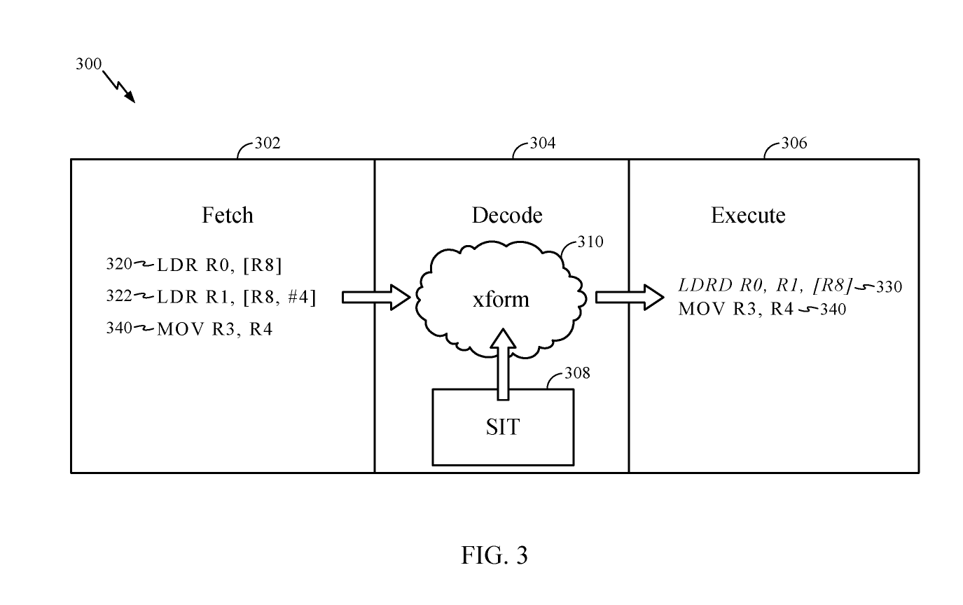

FIG. 3 illustrates an exemplary basic 3-stage processor pipeline 300 that may be included in a processor operating according to aspects of the present disclosure. The three stages of the exemplary processor pipeline are a Fetch stage 302, a Decode stage 304, and an Execute stage 306. During execution of a program by a processor (e.g., processor 101 in FIG. 1), instructions are fetched from memory and/or a cache by the Fetch stage, passed to the Decode stage and decoded, and the decoded instructions are passed to the Execute stage and executed. The pipeline 300 is three-wide; that is, each stage can contain up to three instructions. However, the present disclosure is not so limited and applies to pipelines of other widths.

The group of instructions illustrated in the Fetch stage is passed to the Decode stage, where the instructions are transformed, via the logic “xform” 310. After being transformed, the instructions are pipelined into the Execute stage. The logic “xform” recognizes the paired load commands 320, 322 can be replaced by a more bandwidth-efficient command, in this case a single double-load (LDRD) command 330. As illustrated, the two original load commands 320, 322 are not passed to the Execute stage. The replacement command 330 that replaced the two original load commands is illustrated with italic text. Another command 340 that was not altered is also shown.

According to aspects of the present disclosure, a table, referred to as a Storage Instruction Table (SIT) 308 may be associated with the Decode stage and used to maintain certain attributes of reads/writes that pass through the Decode stage.

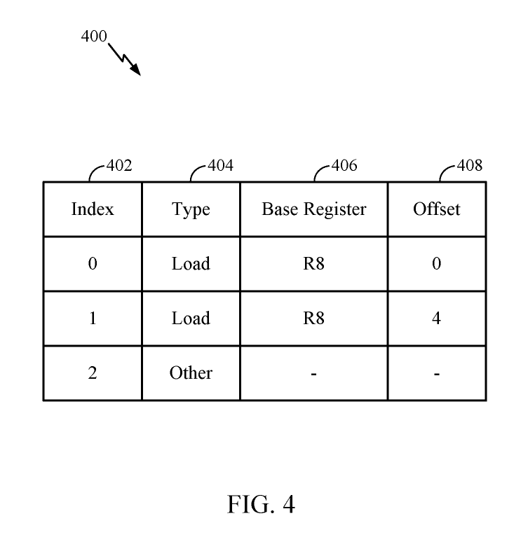

FIG. 4 illustrates an exemplary SIT 400. SIT 400 is illustrated as it would be populated for the group of instructions shown in FIG. 3 when the instructions reach the Decode stage. Information regarding each instruction that passes through the Decode stage is stored in one row of the SIT. The SIT includes four columns. The Index column 402 identifies the instruction position relative to other instructions currently in the SIT. The Type column 404 identifies the type of the instruction as one of “Load,” “Store,” or “Other.” “Other” is used for instructions that neither read from nor write to memory or cache. The Base Register column 406 indicates the register used as the base address by the load or store command. The Offset column 408 stores the immediate value added to the base register when the command is executed.

Although the SIT is illustrated as containing only information about instructions from the Decode stage, the disclosure is not so limited. A SIT may contain information about instructions in other stages. In a processor with a longer pipeline, a SIT could have information about instructions that have already passed through the Decode stage.

A processor operating according to aspects of the present disclosure applies logic to recognize sequences (e.g., patterns) of instructions that may be replaced by other instructions, such as the sequences described above. If a sequence of instructions that may be replaced is recognized, then the processor transforms the recognized instructions into another instruction as the instructions flow towards the Execute stage.

To detect patterns and consolidate instructions as described herein, the pattern detection circuit that acts on the SIT and the pipeline may recognize the previously described sequences of load or store commands that access adjacent memory locations. In particular, the pattern detection circuit may compare the Base Register and Offset of each instruction of Type “Load” with the Base Register and Offset of every other instruction of Type “Load” and determine whether any two “Load” instructions have a same Base Register and Offsets that cause the two “Load” instructions to access adjacent memory locations. The pattern detection circuit may also determine if changes to a Base Register that occur between compared “Load” instructions cause two instructions to access adjacent memory locations. When the pattern detection circuit determines that two “Load” instructions access adjacent memory locations, then the pattern detection circuit replaces the two “Load” instructions with an equivalent, more bandwidth-efficient replacement command. The pattern detection circuit then passes the replacement command to the Execute stage. The pattern detection circuit may also perform similar comparisons and replacements for instructions of Type “Store.” The pattern detection circuit may also determine PC values that will be used for “Load” instructions affecting PC-relative memory locations and then use the determined PC values (and any offsets included in the instructions) to determine if any two “Load” instructions access adjacent memory locations. The pattern detection circuit may perform similar PC value determinations for “Store” instructions affecting PC-relative memory locations and use the determined PC values to determine if any two “Store” instructions access adjacent memory locations.

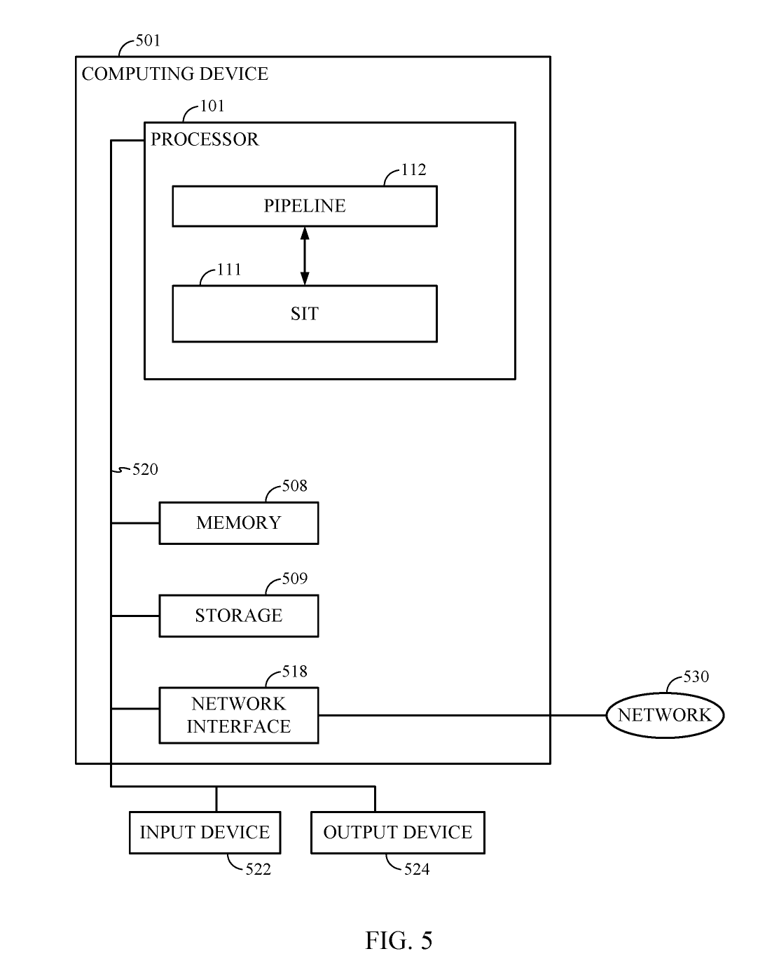

FIG. 5 is a block diagram illustrating a computing device 501 integrating the processor 101 configured to detect patterns of instructions accessing memory using a small portion of bandwidth (e.g. bus-width) and replace the patterns with instructions using a larger portion of bandwidth, according to one aspect. All of the apparatuses and methods depicted in FIGS. 1-4 may be included in or performed by the computing device 501. The computing device 501 may also be connected to other computing devices via a network 530. In general, the network 530 may be a telecommunications network and/or a wide area network (WAN). In a particular aspect, the network 530 is the Internet. Generally, the computing device 501 may be any device which includes a processor configured to implement detecting patterns of instructions accessing memory using a small portion of bandwidth and replacing the patterns with instructions using a larger portion of bandwidth, including, without limitation, a desktop computer, a server, a laptop computer, a tablet computer, and a smart phone.

The computing device 501 generally includes the processor 101 connected via a bus 520 to a memory 508, a network interface device 518, a storage 509, an input device 522, and an output device 524. The computing device 501 generally operates according to an operating system (not shown). Any operating system supporting the functions disclosed herein may be used. The processor 101 is included to be representative of a single processor, multiple processors, a single processor having multiple processing cores, and the like. The network interface device 518 may be any type of network communications device allowing the computing device 501 to communicate with other computing devices via the network 530.

The storage 509 may be a persistent storage device. Although the storage 509 is shown as a single unit, the storage 509 may be a combination of fixed and/or removable storage devices, such as fixed disc drives, solid state drives, SAN storage, NAS storage, removable memory cards or optical storage. The memory 508 and the storage 509 may be part of one virtual address space spanning multiple primary and secondary storage devices.

The input device 522 may be any device operable to enable a user to provide input to the computing device 501. For example, the input device 522 may be a keyboard and/or a mouse. The output device 524 may be any device operable to provide output to a user of the computing device 501. For example, the output device 524 may be any conventional display screen and/or set of speakers. Although shown separately from the input device 522, the output device 524 and input device 522 may be combined. For example, a display screen with an integrated touch-screen may be a combined input device 522 and output device 524.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. Some or all such files may be provided to fabrication handlers who configure fabrication equipment using the design data to fabricate the devices described herein. Resulting products formed from the computer files include semiconductor wafers that are then cut into semiconductor die (e.g., the processor 101) and packaged, and may be further integrated into products including, but not limited to, mobile phones, smart phones, laptops, netbooks, tablets, ultrabooks, desktop computers, digital video recorders, set-top boxes, servers, and any other devices where integrated circuits are used.

In one aspect, the computer files form a design structure including the circuits described above and shown in the Figures in the form of physical design layouts, schematics, a hardware-description language (e.g., Verilog, VHDL, etc.). For example, design structure may be a text file or a graphical representation of a circuit as described above and shown in the Figures. Design process preferably synthesizes (or translates) the circuits described below into a netlist, where the netlist is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. In another embodiment, the hardware, circuitry, and method described herein may be configured into computer files that simulate the function of the circuits described above and shown in the Figures when executed by a processor. These computer files may be used in circuitry simulation tools, schematic editors, or other software applications.

As used herein, a phrase referring to “at least one of” a list of items refers to any combination of those items, including single members. As an example,” at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method, comprising:
detecting a pattern of pipelined instructions to access memory using a first portion of available bus width; and
in response to detecting the pattern, combining the pipelined instructions into a single instruction to access the memory using a second portion of the available bus width that is wider than the first portion.

2. The method of claim 1, wherein detecting the pattern comprises examining a set of instructions in an instruction set window of a given width of instructions.

3. The method of claim 1, wherein the pipelined instructions combined into the single instruction comprise consecutive instructions.

4. The method of claim 1, wherein:
the pipelined instructions combined into the single instruction comprise non-consecutive instructions; and
detecting the pattern comprises determining that other instructions between the non-consecutive instructions do not alter memory locations accessed by the non-consecutive instructions.

5. The method of claim 1, wherein detecting the pattern comprises comparing instructions in a pipeline to patterns of instructions stored in a table.

6. The method of claim 5, further comprising updating the table based on instructions recently detected in the pipeline.

7. The method of claim 1, wherein:
detecting the pattern comprises detecting pipelined instructions to store values of a first bit-width in consecutive memory locations; and
the single instruction comprises an instruction to store a single value of a second bit-width in a single memory location.

8. The method of claim 1, wherein:
detecting the pattern comprises detecting pipelined instructions to read values of a first bit-width from consecutive memory locations; and
the single instruction comprises an instruction to read a single value of a second bit-width from a single memory location.

9. A processor, comprising:
a pattern detection circuit configured to:
detect a pattern of pipelined instructions to access memory using a first portion of available bus width; and
in response to detecting the pattern, combine the pipelined instructions into a single instruction to access the memory using a second portion of the available bus width that is wider than the first portion.

10. The processor of claim 9, wherein the pattern detection circuit is configured to detect the pattern by examining a set of instructions in an instruction set window of a given width of instructions.

11. The processor of claim 9, wherein the pattern detection circuit is configured to combine consecutive instructions into the single instruction.

12. The processor of claim 9, wherein the pattern detection circuit is configured to:
combine non-consecutive instructions into the single instruction; and
determine that other instructions between the non-consecutive instructions do not alter memory locations accessed by the non-consecutive instructions.

13. The processor of claim 9, wherein the pattern detection circuit is configured to detect the pattern by comparing instructions in a pipeline to patterns of instructions stored in a table.

14. The processor of claim 9, wherein:
the pattern detection circuit is configured to detect the pattern by detecting instructions to store values of a first bit-width in consecutive memory locations; and
the single instruction comprises an instruction to store a single value of a second bit-width in a single memory location.

15. The processor of claim 9, wherein:
the pattern detection circuit is configured to detect the pattern by detecting instructions to read values of a first bit-width from consecutive memory locations; and
the single instruction comprises an instruction to read a single value of a second bit-width from a single memory location.

16. An apparatus, comprising:
means for detecting a pattern of pipelined instructions to access memory using a first portion of available bus width; and
means for combining, in response to detecting the pattern, the instructions into a single instruction to access the memory using a second portion of the available bus width that is wider than the first portion.

17. The apparatus of claim 16, wherein the means for detecting the pattern comprises means for examining a set of instructions in an instruction set window of a given width of instructions.

18. The apparatus of claim 16, wherein the means for combining comprises means for combining consecutive instructions.

19. The apparatus of claim 16, wherein:
the means for combining comprises means for combining non-consecutive instructions; and
the means for detecting the pattern comprises means for determining that other instructions between the non-consecutive instructions do not alter memory locations accessed by the non-consecutive instructions.

20. The apparatus of claim 16, wherein the means for detecting the pattern comprises means for comparing instructions in a pipeline to patterns of instructions stored in a table.
